(19) United States
(12) Patent Application Publication
(10) Pub. No.: US 2024/0295649 A1
(43) Pub. Date: Sep. 5, 2024

(54) FREQUENCY MODULATED CONTINUOUS WAVE RADAR SYSTEM WITH INTERFERENCE MITIGATION

(71) Applicant: Texas Instruments Incorporated, Dallas, TX (US)

(72) Inventors: Sandeep RAO, Bengaluru (IN); Anand DABAK, Plano, TX (US)

(21) Appl. No.: 18/640,669

(22) Filed: Apr. 19, 2024

Related U.S. Application Data
(63) Continuation of application No. 17/478,312, filed on Sep. 17, 2021, now Pat. No. 11,994,575.

(30) Foreign Application Priority Data
Oct. 16, 2020 (IN) 202041045051

(51) Int. Cl. G01S 13/34; G01S 7/02

(52) U.S. Cl. CPC G01S 13/34; G01S 7/021

(57) ABSTRACT

A non-transitory computer-readable storage device stores machine instructions. When executed by one or more processors, the machine instructions cause the one or more processors to determine a first inter-chirp time with respect to a first series of chirps; and determine a second inter-chirp time with respect to a second series of chirps, in which the second inter-chirp time is different than the first inter-chirp time and is based on the first inter-chirp time and a chirp dither value. In another implementation, an oscillator receives chirp configuration signals, which contain the inter-chirp times, and generate the first and second series of chirps with the first and second inter-chirp times, respectively. Transmitter circuitry, coupled to the oscillator, transmits each of the first and second series of chirps with the respective inter-chirp time.

### CROSS-REFERENCE TO RELATED APPLICATIONS

This application claims priority to U.S. application Ser. No. 17/478,312, filed Sep. 17, 2021, which claims priority to India Provisional Application No. 202041045051, filed Oct. 16, 2020, each of which is incorporated by reference herein.

### BACKGROUND

Many driving assistance systems implement frequency modulated continuous wave (FMCW) radar systems to aid in collision warning, blind spot warning, lane change assistance, parking assistance, and rear collision warning. The basic transmit signal of FMCW radar is a frequency ramp, also commonly known as a “chirp.” A chirp is a signal whose frequency varies linearly with time. For example, a millimeter wave radar system might transmit a chirp with a 4 GigaHertz (GHz) bandwidth that starts at 77 GHZ and linearly increases to 81 GHz. The transmitted chirp reflects off one or more objects, and the reflected signal is received at one or more receiver antennas. An FMCW radar system transmits a series of these equally spaced chirps in a unit called a frame. The reflected signal is down-converted, digitized and then processed to obtain the range, velocity, and angle of arrival for objects in front of the radar system.

As the prevalence of radar systems in automotive, manufacturing, and other contexts increases, the likelihood of interference between radar systems increases as well. One technique to reduce or mitigate radar interference is to dither the intra-frame chirp timing across chirps in a radar frame. However, intra-frame chirp dithering can increase the noise floor of the radar system and reduce the detection sensitivity for weak target objects.

### SUMMARY

In an example, a non-transitory computer-readable storage device stores machine instructions. When executed by one or more processors, the machine instructions cause the one or more processors to determine a first inter-chirp time with respect to a first series of chirps; and determine a second inter-chirp time with respect to a second series of chirps, in which the second inter-chirp time is different than the first inter-chirp time and is based on the first inter-chirp time and a chirp dither value.

In another example, a radar circuit includes an oscillator configured to receive chirp configuration signals and generate n series of chirps based on the chirp configuration signals, including generate each series of chirps of the n series of chirps with a respective inter-chirp time that is different for each series of chirps; and transmitter circuitry coupled to the oscillator, the transmitter circuitry configured to transmit each series of chirps with the respective inter-chirp time. Each series of chirps may be considered a frame of chirps.

In some implementations, the radar circuit couples to processing circuitry that is configured to generate the chirp configuration signals. The processing circuitry may determine a nominal chirp period Tc and n distinct chirp dither values, including a respective chirp dither value for each series of chirps that is different for each series of chirps; and then determine the respective inter-chirp time of each series of chirps as a sum of Tc and the respective chirp dither value. The processing circuitry may also determine a chirp dither range, within which each of the respective chirp dither values lie. The processing circuitry may also determine the nominal chirp period Tc based on a threshold unambiguous velocity associated with the radar circuit; and determine a maximum chirp dither defining an upper end of the chirp dither range based on a threshold deviation from the threshold unambiguous velocity. The processing circuitry may also determine a nominal frame period TF; determine a frame dither range; determine, for each frame of chirps, a respective frame dither value within the frame dither range; and determine a respective frame period for each frame of chirps as a sum of TF and the respective frame dither value.

The transmitter circuitry may be further configured to transmit each frame of chirps with the respective inter-chirp time and with the respective frame period.

### BRIEF DESCRIPTION OF THE DRAWINGS

For a detailed description of various examples, reference will now be made to the accompanying drawings in which:

FIG. 1 shows a block diagram of an example radar system.

FIG. 2A illustrates waveforms of a frame of undithered chirp signals in accordance with an example.

FIG. 2B illustrates an example representation of a range fast Fourier transform (FFT) for the undithered chirp signals in the frame shown in FIG. 2A.

FIG. 2C illustrates a waveform of a Doppler FFT for the undithered chirp signals in the frame shown in FIG. 2A.

FIG. 3A illustrates waveforms of intra-frame dithered chirp signals in accordance with an example.

FIG. 3B illustrates an example representation of a range fast Fourier transform (FFT) for the intra-frame dithered chirp signals in the frame shown in FIG. 3A.

FIG. 3C illustrates a waveform of a Doppler FFT for the intra-frame dithered chirp signals in the frame shown in FIG. 3A.

FIG. 4A illustrates waveforms of inter-frame dithered chirp signals in accordance with an example.

FIG. 4B illustrates waveforms of dithered frames of chirp signals in accordance with an example.

FIG. 4C illustrates waveforms of chirp signals with varying slopes in accordance with an example.

FIG. 4D illustrates waveforms of dithered frames of inter-frame dithered chirp signals with varying slopes in accordance with the examples shown in FIGS. 4A, 4B, and 4C.

FIG. 5 illustrates a graph of the cumulative distribution function of the number of cells per range bin that are affected by an interfering signal.

FIG. 6 illustrates, in flowchart form, an example process for dithering radar frames in accordance with an example.

The same reference number is used in the drawings for the same or similar (either by function and/or structure) features.

### DETAILED DESCRIPTION

The disclosed radar systems implement inter-frame chirp dithering to mitigate interference from other radar systems. Inter-frame chirp dithering reduces the number of cells affected by the interfering signal in each particular range bin without introducing phase noise into the Doppler fast Fourier transform as intra-frame dithering does. In addition to, or alternatively, the radar systems can implement dithering in the period from the start of one radar frame to the start of another radar frame. In further addition to, or alternatively, the radar system can implement slope dithering to adjust the slope of the radar chirps from one radar frame to another radar frame.

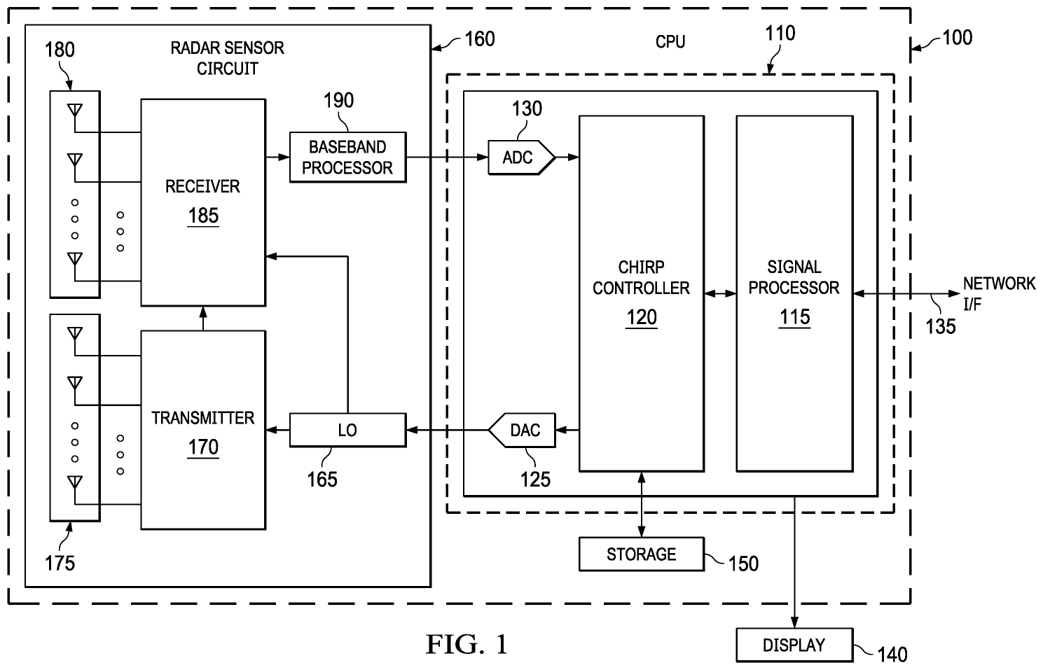

FIG. 1 shows a block diagram of an example radar system 100. Radar system 100 may be used in a vehicle, such as for a driver assistance system in an automobile. In this example, radar system 100 includes a radar sensor circuit 160, a central processor unit (CPU) 110, a display 140, and storage 150. Radar sensor circuit 160 includes a transmitter 170 that drives an antenna array 175 of one or more transmitter (TX) antennas. A receiver 185 receives signals from an antenna array 180 of one or more receiver (RX) antennas. A baseband processor 190 amplifies and filters the received signals that are reflected from objects in the path of the transmitted chirp signals. In this example radar system 100, transmitter 170 operates in the 77 GHz region and produces a frequency modulated continuous wave (FMCW) signal. The continuous wave signal is frequency modulated to form a series of chirps using a local oscillator (LO) 165. In example radar system 100, the TX antenna array 175 and RX antenna array 180 are stationary. In other examples, the antenna arrays may be configured to transmit and receive across a range of area, such as by mechanical movement.

FMCW radar, also referred to as continuous-wave frequency-modulated (CWFM) radar, is capable of determining distance, velocity, and angle of arrival. In a FMCW system, the transmitted chirp signal of a known stable frequency continuous wave varies up and down in frequency over a fixed period of time by a modulating signal. Received reflections are then mixed with the transmitted chirp signal to produce a received beat signal, which will give the distance, velocity, and angle of arrival for the target object after signal processing. Frequency differences between the received reflections and the transmitted chirp signal increase with delay and are therefore proportional to distance.

The phase differences between the received reflections across consecutive chirps allow the velocity of target objects to be computed. The phase differences between the received reflections at a first receiver antenna and the received reflections at a second receiver antenna allow the angle of arrival of target objects to be computed. Thus with an FMCW radar system, the distance between the target object and the radar system, relative velocity of the target object, relative angle of the target object and the like can be calculated.

During normal operation, linear frequency chirps are transmitted, and reflected signals are received. The receiver and transmitter are arranged as a homodyne system so that the received reflections are down-converted directly into the baseband in receiver 185 using a copy of the transmitted signal from LO 165. The baseband signals are then filtered and amplified by filters and variable gain amplifiers by baseband processor 190. After converting the baseband signals into the digital domain, time domain to frequency domain transforms such as fast Fourier transforms (FFTs) may be applied and other signal processing performed in order to determine the distance, velocity, and angle of arrival between the target object and the radar system 100. For example, the down-converted and digitized received signal corresponding to each chirp is first transformed using an FFT (called the range FFT). The range FFT produces a series of range bins with the value of each range bin denoting the signal strength of reflected targets at the corresponding range. A Doppler FFT is then performed for each range bin across all the chirps in a frame to estimate the velocities of reflected targets.

CPU 110 comprises one or more CPU cores, digital signal processors, application specific integrated circuits, and the like. The term “CPU” (singular) is used herein to refer to either a single or multiple CPU cores, and to broadly describe central processing units, digital signal processors, application specific integrated circuits, and the like. CPU 110 includes a chirp controller 120 that receives a stream of data from receiver antenna array 180 via an analog to digital converter (ADC) 130 and performs chirp generation and control of the transmitter via a digital to analog converter (DAC) 125. A varying voltage tuning control signal from DAC 125 is used to control LO 165. CPU 110 also includes a signal processor 115 that may perform signal processing for determining a velocity, an angle of arrival, distance between the target object and radar system 100, and the like.

Signal processor 115 can provide the determined values to display 140 and/or communicate with other systems via a network interface 135. Network 135 may include various combinations of local area networks (LANs), wide area networks (WANs), the internet and/or other known or later developed wired or wireless communication mechanisms, for example. Storage 150 may be used to store instructions and data received from antenna 180 or signal processor 115. Storage 150 may be any appropriate storage medium, such as a static random access memory (SRAM).

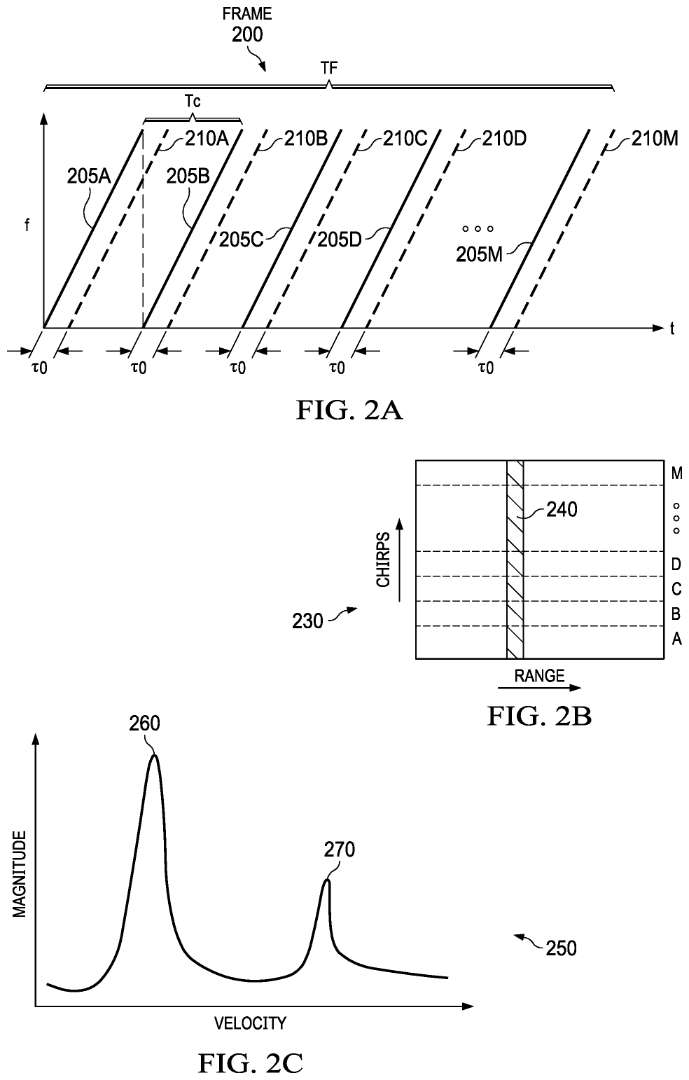

FIG. 2A illustrates waveforms of undithered chirp signals 205 in accordance with an example. A frame 200 with a period TF includes a number M of undithered chirp signals 205 transmitted at equal intervals based on a chirp period Tc. An interfering radar system may have similar, interfering chirp signals 210A-M as the undithered chirp signals 205A-M, for example because the interfering radar system has the same manufacturer. With undithered chirp signals, each interfering chirp signal 210 has the same delay to with respect to each corresponding undithered chirp signal 205.

FIG. 2B illustrates an example representation 230 of a range FFT performed on the received signal corresponding to the transmission of the undithered chirp signals 205A-M shown in FIG. 2A. Performing an FFT on received data corresponding to each chirp 205 resolves the received radar reflections into range bins. In addition to reflections from the transmitted chirp signals 205A-M, the received signal also includes the interfering chirp signals 210A-M. Because the interfering signals 210A-M have the same delay to with respect to the corresponding undithered chirp signal 205A-M, the interfering signals 210 appear as objects at a particular range bin 240. Any genuine radar reflections at the particular range bin 240 with a lower power than the interfering signals 210 are obscured. FIG. 2C illustrates a waveform 250 of a Doppler FFT performed on a range bin other than range bin 240 from the range FFT of the chirps 205 in frame 200 shown in FIG. 2A. The particular range bin does not include the interfering signals 210. Performing an FFT across range bin for the undithered chirps 205A-N in the frame 200 resolves radar reflections into velocity bins. With no timing dither, there is no corruption in phase across chirps 205A-M, and so both the strong target 260 and the weak target 270 are visible in the Doppler FFT.

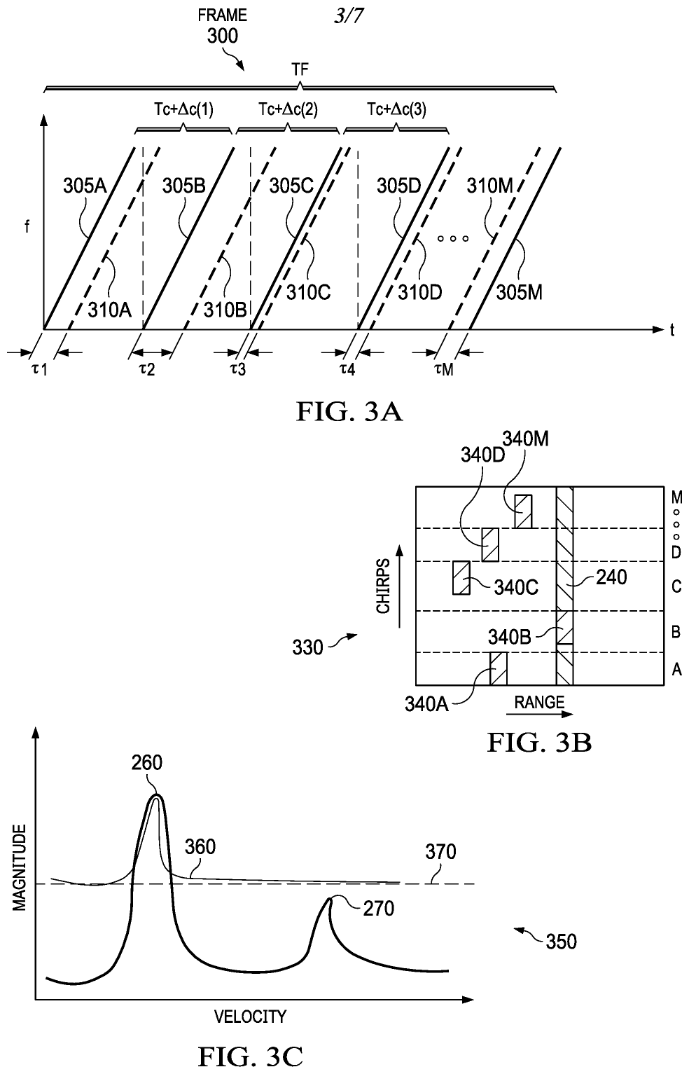

FIG. 3A illustrates waveforms of intra-frame dithered chirp signals 305 in accordance with an example. A frame 300 with a period TF includes a number M of dithered chirp signals 305 transmitted at different intervals. For example, a chirp period Tc and a first chirp dither Δc(1) are added together for a first interval between the start of a first chirp signal 305A to the start of a second chirp signal 305B. The chirp period Tc and a second chirp dither Δc(2) are added together for a second interval between the start of the second chirp signal 305B to the start of a third chirp signal 305C. Each chirp signal 305 in frame 300 may be associated with a unique chirp dither Δc, and another frame of chirp signals may have the same or different chirp dithers as frame 300. The duration of the chirp dither Δc can be five to ten percent of the chirp period Tc, in some implementations. Each radar system randomly and independently chooses the chirp dither Δc.

An interfering radar system may have similar, interfering chirp signals 310A-N as the intra-frame dithered chirp signals 305A-M, for example because the interfering radar system has the same manufacturer. The chirp dither Δc for the interfering chirp signals 310A-M is different from the chirp dither Δc for the chirp signals 305A-M because the radar system and the interfering radar system select the corresponding chirp dither Δc independently from each other. Hence with intra-frame dithered chirp signals, each interfering chirp signal 310 has a unique delay τ with respect to the corresponding intra-frame dithered chirp signal 305. For example, the interfering chirp signal 310A has a first delay τ1 with respect to the intra-frame dithered chirp signal 305A, while the interfering chirp signal 310B has a second delay τ2 with respect to the intra-frame dithered chirp signal 305B. As another example, the interfering chirp signal 310M precedes the intra-frame dithered chirp signal 305M by the delay τ(M).

FIG. 3B illustrates an example representation 330 of a range FFT performed on the received signal corresponding to the transmission of the intra-frame dithered chirp signals 305A-M shown in FIG. 3A. Performing an FFT on received data corresponding to each chirp 305 resolves the received radar reflections into range bins. In addition to reflections from the transmitted chirp signals 305A-M, the received signal also includes the interfering chirp signals 310A-M. Because the interfering signals 310A-M have differing delays t with respect to the corresponding chirp signal 305A-M, the interfering signals 310 appear as objects in different range bins 340A-M rather than the same range bin 240 as shown in FIG. 2B. Thus, the maximum number of cells per range bin affected by the interfering signals 310 is reduced compared to the undithered chirp signals 205 and shown in FIG. 2A. Techniques to detect and repair the affected cells are more effective on the reduced number of affected cells per range bin.

FIG. 3C illustrates a waveform 350 of a Doppler FFT performed on a particular range bin from the range FFT of the chirps 305 in frame 300 shown in FIG. 3A. The particular range bin does not include the interfering signals 310. Since the inter-chirp timing varies across chirps 305 in frame 300, phase noise and a corresponding noise floor 370 are introduced into the Doppler FFT. The magnitude of the noise floor 370 relative to the peak value of the strong target 360 corresponds to an amount of chirp dithering. For example, more chirp dithering corresponds to a higher noise floor 370, while less chirp dithering corresponds to a lower noise floor 370. While the strong target is clearly visible in the Doppler FFT 360, the weak target 270 shown in the waveform 250 of the Doppler FFT for the chirps 205 is lower power than the noise floor 370 and obscured in the Doppler FFT for the intra-frame dithered chirps 305. Thus although intra-frame dithered chirps 305 reduce the maximum number of interference affected cells per range bin, the intra-frame dithering introduces a noise floor in the Doppler FFT that is present in all range bins, regardless of the presence or absence of interference in the particular range bin, and is not present with the undithered chirps 205.

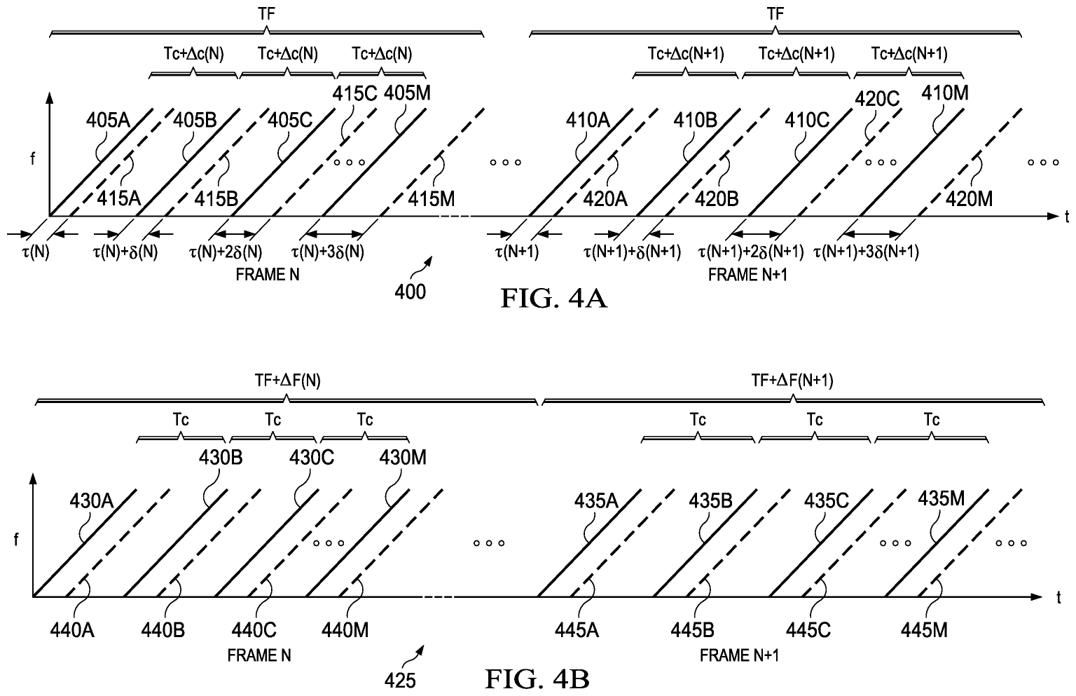

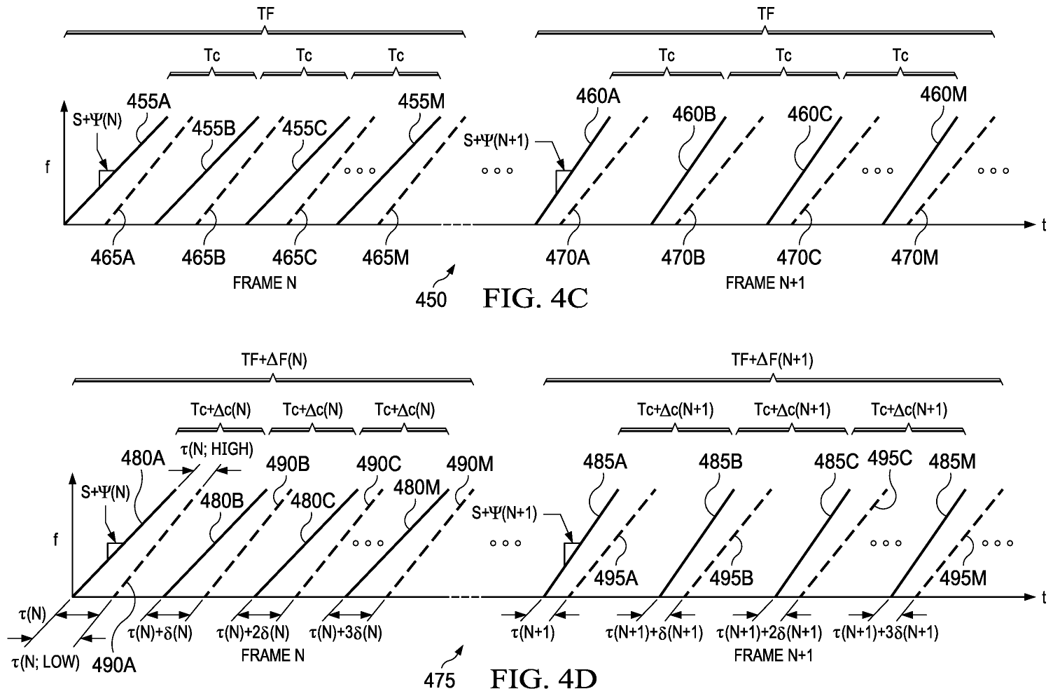

FIG. 4A illustrates waveforms 400 of inter-frame dithered chirp signals in accordance with an example. In a first frame N with a period TF, the inter-frame dithered chirp signals 405A-M are transmitted at fixed intervals based on the chirp period Tc and a first chirp dither Δc(N). Consider an interfering chirp signal 415 which also has inter-frame dithered chirp signals transmitted at fixed intervals based on the same chirp period Tc and a different chirp dither Δd(N). The difference δ(N) between the chirp dithers Δc(N) and Δd(N) causes the delay τ with respect to the corresponding inter-frame dithered chirp signal 405 to change across the frame N. For example, the interfering chirp signal 415A has an initial delay τ(N) with respect to the corresponding chirp signal 405A, the interfering chirp signal 415B has a second delay τ(N) plus δ(N) with respect to the corresponding chirp signal 405B, and the interfering chirp signal 415C has a third delay τ(N) plus two times δ(N) with respect to the corresponding chirp signal 405C. Here, δ(N) represents the difference in chirp dither between the chirp signals 405 and the interfering chirp signals 415 (i.e., δ(N)=Δd(N)−Δc(N)) and can be either positive or negative.

In the subsequent frame N+1 with the same period TF, the inter-frame dithered chirp signals 410A-M are transmitted at fixed intervals based on the chirp period Tc and a second chirp dither Δc(N+1). For an interfering chirp signal 420 with a different chirp dither Δd(N+1), the difference δ(N+1) between the chirp dithers Δc(N+1) and Δd(N+1) causes the delay τ with respect to the corresponding interframe dithered chirp signal 410 to change across the frame N+1. For example, the interfering chirp signal 420A has an initial delay τ(N+1) with respect to the corresponding chirp signal 410A, the interfering chirp signal 420B has a second delay τ(N+1) plus δ(N+1) with respect to the corresponding chirp signal 410B, and the interfering chirp signal 420C has a third delay τ(N+1) plus two times δ(N+1). The initial delay τ(N+1) for the frame N+1 may be the same or different from the initial delay τ(N) for the frame N.

The chirp dither Δc is fixed across chirps within a frame and varies across frames. Similar to the intra-frame dithered chirp signals 305 shown in FIG. 3A, the changing delay between the inter-frame dithered chirp signals 405 and the interfering chirp signals 415 and between the inter-frame dithered chirp signals 410 and the interfering chirp signals 420 causes the interfering signals 415 and 420 to appear as objects in different range bins, rather than a same range bin. The interchirp delay Tc+Δc(N) between sequential chirp signals 405 in the frame N and the interchirp delay Tc+Δc(N+1) between sequential chirp signals 410 in the frame N+1 are constant within each frame, and so there is no corruption in phase across chirps 405A-M and across chirps 410A-M, similar to the undithered chirp signals 205 shown in FIG. 2A.

FIG. 4B illustrates waveforms 425 of dithered frames of chirp signals in accordance with an example. In a first frame N, the chirp signals 430A-M are transmitted at fixed intervals based on the chirp period Tc, and the period TF of the frame N is dithered with a frame dither ΔF(N), such that the length of time from the start of frame N to the start of frame N+1 is TF+ΔF(N). In a second frame N+1, the chirp signals 435A-M are transmitted at the same fixed intervals based on the chirp period Tc as in the first frame N, but the period TF of the frame N+1 is dithered with a second frame dither ΔF(N+1), such that the length of time from the start of frame N+1 to the start of frame N+2 is TF+ΔF(N+1). The frame dither does not affect the number or duration of chirps in each frame. Because the chirp signals 430 and 435 are transmitted at fixed intervals across the frames N and N+1, no phase noise or noise floor is introduced into the Doppler FFT. Frame dithering is often used in combination with inter-frame chirp dithering.

FIG. 4C illustrates waveforms 450 of chirp signals with dithered slopes in accordance with an example. In a first frame N with a period TF, the slope-dithered chirps 455A-M are transmitted at fixed intervals based on the chirp period Tc and have a slope S plus a first slope dither Ψ(N). For an interfering chirp signal 465, the first slope dither Ψ(N) causes the delay τ with respect to the corresponding slope-dithered chirp signal 455 to vary based on frequency. For example, the interfering chirp signal 465A has a sharper slope than the slope-dithered chirp signal 455A, and the delay τ is greater at lower frequencies than at higher frequencies.

In the subsequent frame N+1 with the same period TF, the slope-dithered chirps 460A-N are transmitted at fixed intervals based on the chirp period Tc and have a slope S plus a second slope dither Ψ(N+1). For an interfering chirp signal 470, the second slope dither Ψ(N+1) causes the delay τ with respect to the corresponding slope-dithered chirp signal 460 to vary based on frequency. For example, the interfering chirp signal 470A has a sharper slope than the slope-dithered chirp signal 460A, and the delay τ is greater at lower frequencies than at higher frequencies.

The changing delay between the slope-dithered chirp signals 455 and the interfering chirp signals 465 and between the slope-dithered chirp signals 460 and the interfering chirp signals 470 over the course of each chirp causes the interfering signals 465 and 470 to spread across different range bins, rather than a same range bin. The inter-chirp delay Tc between sequential chirp signals and the slope S+Ψ(N) of chirp signals 455 and 460 are constant within each frame, and so there is no corruption in phase across chirps 455A-M and across chirps 460A-M. The Doppler-FFT across chirps 455 in frame N and across chirps 460 in frame N+1 does not show a noise floor like the noise floor 370 shown in FIG. 3C.

The inter-frame dithering, frame dithering, and slope dithering techniques described in FIG. 4A, FIG. 4B, and FIG. 4C, respectively, can be used in combination with one or more of the other techniques to further reduce the number of cells per range bin affected by the interfering chirp signals and to further reduce the amount of phase noise and the magnitude of the corresponding noise floor introduced into the Doppler FFT. FIG. 4D illustrates waveforms 475 of dithered frames of inter-frame dithered chirp signals with varying slopes in accordance with the examples shown in FIGS. 4A, 4B, and 4C.

In a first frame N, the inter-frame and slope-dithered chirps signals 480A-M are transmitted at fixed intervals based on the chirp period Tc and a first chirp dither Δc(N) and have a slope S plus a first slope dither Ψ(N). The period TF of the frame N is dithered with a frame dither ΔF(N). For an interfering chirp signal 490, the first chirp dither Δc(N) and the first slope dither Ψ(N) cause the delay τ with respect to the corresponding inter-frame and slope-dithered chirp signal 480 to vary across the corresponding chirp signal 480 and to increase across the frame N.

For example, the interfering chirp signal 490A has an initial delay τ(N; low) with respect to the low frequencies of the corresponding chirp signal 480A and an initial delay τ(N; high) with respect to the high frequencies of the corresponding chirp signal 480A. The interfering chirp signal 490B has a second delay τ(N; low) plus δ(N) with respect to the low frequencies of the corresponding chirp signal 480B and a second delay τ(N; high) plus δ(N) with respect to the high frequencies of the corresponding chirp signal 480B. The interfering chirp signal 490C has a third delay τ(N; low) plus two times δ(N) with respect to the low frequencies of the corresponding chirp signal 480C and a third delay τ(N; high) plus two times δ(N) with respect to the high frequencies of the corresponding chirp signal 480C.

In the second frame N+1, the inter-frame and slope-dithered chirps signals 485A-N are transmitted at fixed intervals based on the chirp period Tc and a second chirp dither Δc(N+1) and have a slope S plus a second slope dither Ψ(N+1). The period TF of the frame N+1 is dithered with a second frame dither ΔF(N+1). For an interfering chirp signal 495, the second time dither Δc(N+1) and the second slope dither Ψ(N+1) cause the delay τ with respect to the corresponding inter-frame and slope-dithered chirp signal 485 to vary across the corresponding chirp signal 485 and to increase across the frame N+1.

For example, the interfering chirp signal 495A has an initial delay τ(N+1; low) with respect to the low frequencies of the corresponding chirp signal 485A and an initial delay τ(N+1; high) with respect to the high frequencies of the corresponding chirp signal 485A. The interfering chirp signal 495B has a second delay τ(N+1; low) plus δ(N+1) with respect to the low frequencies of the corresponding chirp signal 485B and a second delay τ(N+1; high) plus δ(N+1) with respect to the high frequencies of the corresponding chirp signal 485B. The interfering chirp signal 495C has a third delay τ(N+1; low) plus two times δ(N+1) with respect to the low frequencies of the corresponding chirp signal 485C and a third delay τ(N+1; high) plus two times δ(N+1) with respect to the high frequencies of the corresponding chirp signal 485C.

The combination of inter-frame and slope dithering causes the delay between the interfering signals 490 and 495 and the corresponding chirp signals 480 and 485 to vary across a single chirp and across the frames N and N+1. Thus, the interfering signals 490 and 495 appear as objects in different range bins, rather than a same range bin, and affect fewer cells in any one range bin than the interfering signals 415 and 420 shown in FIG. 4A, the interfering signals 440 and 445 shown in FIG. 4B, and the interfering signals 465 and 470 shown in FIG. 4C. Techniques to detect and repair the affected cells are more effective on the reduced number of affected cells.

Both the inter-chirp delays and the slopes are constant within each frame. For example in frame N, the inter-chirp delay Tc+Δc(N) and the slope S+Ψ(N) are constant, and in frame N+1, the inter-chirp delay Tc+Δc(N+1) and the slope S+Ψ(N+1) are constant. Thus, there is no corruption in phase across chirps 480A-M in frame N or across chirps 485A-M in frame N+1. The Doppler-FFT across chirps 480A-M in frame N or across chirps 485A-M does not show a noise floor like the noise floor 370 shown in FIG. 3C.

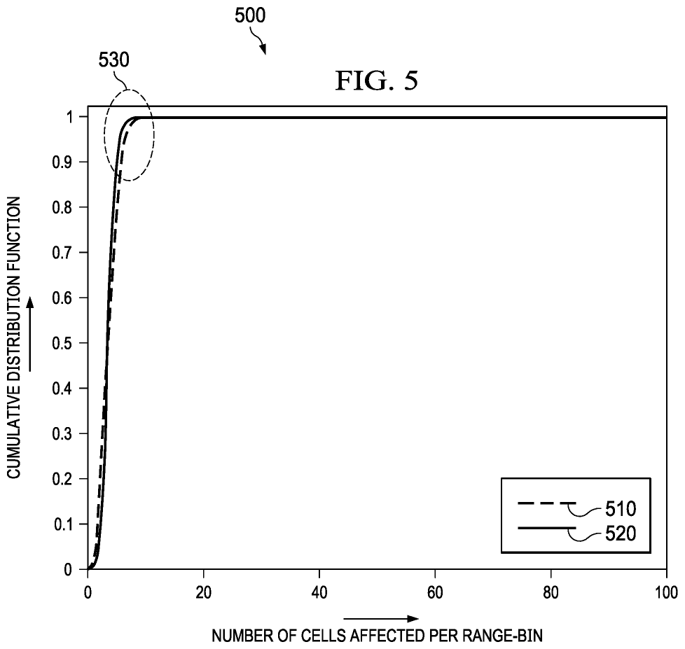

FIG. 5 illustrates a graph 500 of the cumulative distribution function of the number of cells per range bin that are affected by an interfering signal. The cumulative distribution function is an indication of how well a particular dithering technique spreads the interfering chirp signals across range bins. In this example, a frame of 256 chirps were transmitted in a frame period TF of approximately 6.4 milliseconds with a chirp period Tc of approximately 25 microseconds. 20 interfering radar systems were used to compare the cumulative distribution function 520 for an inter-frame dithering technique with a dither of plus or minus one microsecond and the cumulative distribution function 510 for an intra-frame dithering technique with a dither of plus or minus 3.75 microseconds. As shown in callout 530, the cumulative distribution function 520 for the inter-frame dithering technique discussed herein with respect to FIG. 4A is substantially the same as the cumulative distribution function 510 for the intra-frame dithering technique discussed herein with respect to FIG. 3A. While the inter-frame and intra-frame dithering techniques may have substantially the same improvements with respect to interference mitigation in the range FFT, that is, the number of cells per range bin affected by the interference signals, the inter-frame dithering technique introduces less phase noise and a lower corresponding noise floor into the Doppler FFT than the intra-frame dithering technique.

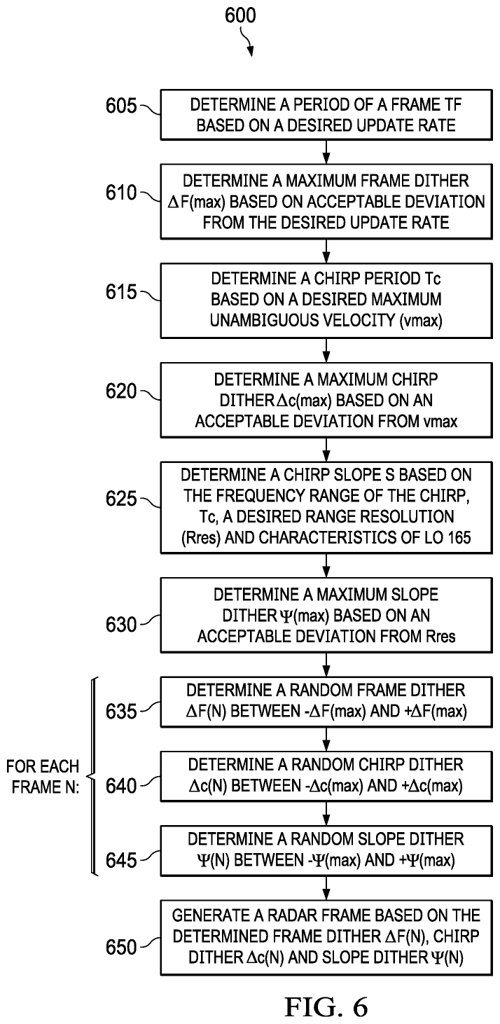

FIG. 6 illustrates, in flowchart form, an example process 600 for dithering radar frames according to an example. The process 600 is performed by a processing unit executing instructions stored in a non-transitory computer-readable medium such as a static random access memory (SRAM). For example, the process 600 can be performed by the chirp controller 120 executing instructions stored in storage 150 shown in FIG. 1. The process 600 begins at step 605, where the chirp controller 120 determines a period of a frame TF based on a desired update rate for the radar system 100. For example, if the desired update rate for the radar system 100 is 60 frames per second, the frame period TF is approximately 17 milliseconds (ms).

At step 610, the chirp controller 120 determines a maximum frame dither ΔF(max) based on an acceptable deviation α(F) from the desired update rate. That is, the maximum frame dither ΔF(max) can be set to α(F) times the frame period TF. Returning to the previous example, if a deviation α(F) of plus or minus 5% from the desired update rate is acceptable, then the maximum frame dither ΔF(max) can be set to approximately one ms. At step 615, the chirp controller 120 determines a chirp period Tc based on a desired maximum unambiguous velocity vmax for the radar system 100. For example, the chirp period Tc may be represented as:

$$T c = \frac{λ}{4 v max}$$

where λ represents a wavelength of the chirp.

At step 620, the chirp controller 120 determines a maximum chirp dither Δc(max) based on an acceptable deviation α(c) from the desired maximum unambiguous velocity vmax. That is, the maximum chirp dither Δc(max) can be set to α(c) times the chirp period Tc. For example, if a deviation α(c) of plus or minus 2% from the desired maximum unambiguous velocity vmax is acceptable, then the maximum chirp dither Δc(max) can be set to approximately 0.02 Tc.

At step 625, the chirp controller 120 determines a chirp slope S based on the frequency range of the chirp, the chirp period Tc, the desired range resolution, and characteristics of the LO 165. For example, the chirp slope S may be determined as:

$$S = \frac{c}{2 ( T c ) ( R r e s )}$$

where c represents the speed of light and Rres represents the desired range resolution. Additionally, the chirp slope S may be adjusted based on the characteristics of the LO 165 such that the LO 165 can consistently and efficiently generate chirps with the appropriate slope S. At step 630, the chirp controller 120 determines a maximum slope dither Ψ(max) based on an acceptable deviation α(r) from the desired range resolution. That is, the maximum slope dither Ψ(max) can be set to α(r) times the chirp slope S.

For each radar frame N, the chirp controller 120 performs one or more of steps 635, 640, and 645, and step 650. At step 635, the chirp controller 120 determines a random frame dither ΔF(N) between negative ΔF(max) and positive ΔF(max). At step 640, the chirp controller 120 determines a random chirp dither Δc(N) between negative Δc(max) and positive Δc(max). At step 645, the chirp controller 120 determines a random slope dither Ψ(N) between negative Ψ(max) and positive Ψ(max). At step 650, the chirp controller 120 causes LO 165 in radar sensor circuit 160 to generate a radar frame based on the one or more determined frame dither ΔF(N), chirp dither Δc(N), and slope dither Ψ(N).

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof. As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Circuits described herein are reconfigurable to include additional or different components to provide functionality at least partially similar to functionality available prior to the component replacement. Unless otherwise stated, “about,” “approximately,” or “substantially” preceding a value means +/−10 percent of the stated value. Modifications are possible in the described examples, and other examples are possible within the scope of the claims.

Modifications are possible in the described embodiments, and other embodiments are possible, within the scope of the claims.

What is claimed is:

1. A non-transitory computer-readable storage device storing machine instructions, when executed by one or more processors, cause the one or more processors to:
determine a first inter-chirp time with respect to a first series of chirps; and
determine a second inter-chirp time with respect to a second series of chirps, in which the second inter-chirp time is different than the first inter-chirp time and is based on the first inter-chirp time and a chirp dither value.

2. The storage device of claim 1, wherein the machine instructions, when executed by the one or more processors, further cause the one or more processors to:
determine a first slope for each chirp of the first series of chirps; and
determine a second slope for each chirp of the second series of chirps, in which the second slope is different than the first slope and is based on the first slope and a slope dither value.

3. The storage device of claim 1, wherein the machine instructions, when executed by one or more processors, further cause the one or more processors to:
determine a chirp dither range; and
determine the chirp dither value such that it is within the chirp dither range.

4. The storage device of claim 2, wherein the machine instructions, when executed by the one or more processors, further cause the one or more processors to:
determine a chirp slope range; and
determine the slope dither value such that it is within the chirp slope dither range.

5. The storage device of claim 1, wherein the chirp dither value is a first chirp dither value, and wherein the machine instructions, when executed by the one or more processors, further cause the one or more processors to:
determine a third inter-chirp time with respect to a third series of chirps, the third inter-chirp time based on the first inter-chirp time and a second chirp dither value that is different from the first chirp dither value.

6. The storage device of claim 1, the machine instructions, when executed by the one or more processors, further cause the one or more processors to:
generate chirp configuration signals to cause a radar circuit to:
generate the first series of chirps with the first inter-chirp time; and
generate the second series of chirps with the second inter-chirp time.

7. The storage device of claim 2, wherein the machine instructions, when executed by the one or more processors, further cause the one or more processors to generate chirp configuration signals to cause a radar circuit to:
generate the first series of chirps with the first inter-chirp time and the first slope;
generate the second series of chirps with the second inter-chirp time and the second slope.

8. The storage device of claim 2, wherein:
each chirp of the first series of chirps has a first bandwidth, and the first slope is determined based on the first bandwidth; and
each chirp of the second series of chirps has a second bandwidth, and the second slope is determined based on the second bandwidth.

9. The storage device of claim 5, wherein the first series of chirps represents a first frame of chirps, the second series of chirps represents a second frame of chirps, and the third series of chirps represents a third frame of chirps, wherein the machine instructions, when executed by the one or more processors, further cause the one or more processors to:
determine a first frame period representing a length of time from a start of the first frame of chirps to a start of the second frame of chirps; and
determine a second frame period representing a length of time from a start of the second frame of chirps to a start of the third frame of chirps, in which the second frame period is different than the first frame period and is based on the first frame period and a frame dither value.

10. The storage device of claim 1, wherein the machine instructions, when executed by the one or more processors, further cause the one or more processors to:
determine a nominal inter-chirp time, wherein
the first inter-chirp time is determined as a sum of the nominal inter-chirp time and a first chirp dither value; and
the second inter-chirp time is determined as a sum of the nominal inter-chirp time and a second chirp dither value, the second chirp dither value including the chirp dither value.

11. A radar circuit comprising:
an oscillator configured to receive chirp configuration signals and generate n series of chirps based on the chirp configuration signals, including generate each series of chirps of the n series of chirps with a respective inter-chirp time that is different for each series of chirps; and
transmitter circuitry coupled to the oscillator, the transmitter circuitry configured to transmit each series of chirps with the respective inter-chirp time.

12. The radar circuit of claim 11, wherein the chirp configuration signals specify chirp slope information, and, for each series of chirps of the n series of chirps, the oscillator is further configured to generate each chirp with a respective slope based on the chirp slope information, in which the respective slope for each series of chirps is different.

13. The radar circuit of claim 12, in which the oscillator is configured to be coupled to processing circuitry that is configured to generate the chirp configuration signals.

14. The radar circuit of claim 13, wherein the processing circuitry includes a controller and a signal processor coupled to the controller.

15. The radar circuit of claim 13, wherein:
the processing circuitry is configured to determine a nominal chirp period Tc and n distinct chirp dither values, including a respective chirp dither value for each series of chirps that is different for each series of chirps; and
the respective inter-chirp time of each series of chirps is determined as a sum of Tc and the respective chirp dither value.

16. The radar circuit of claim 15, wherein the processing circuitry is further configured to determine a chirp dither range, each of the respective chirp dither values being with the chirp dither range.

17. The radar circuit of claim 16, wherein the processing circuitry is further configured to:
determine the nominal chirp period Tc based on a threshold unambiguous velocity associated with the radar circuit; and
determine a maximum chirp dither defining an upper end of the chirp dither range based on a threshold deviation from the threshold unambiguous velocity.

18. The radar circuit of claim 16, wherein each series of chirps of the n series of chirps is a frame of chirps, wherein the processing circuitry is further configured to:
determine a nominal frame period TF;
determine a frame dither range;
determine, for each frame of chirps, a respective frame dither value within the frame dither range; and
determine a respective frame period for each frame of chirps as a sum of TF and the respective frame dither value.

19. The radar circuit of claim 18, wherein the transmitter circuitry is further configured to transmit each frame of chirps with the respective inter-chirp time and with the respective frame period.

20. The radar circuit of 11, further comprising:
receiver circuitry coupled to the transmitter circuitry and to the oscillator.
